(19) United States
(12) Patent Application Publication
(10) Pub. No.: US 2006/0239591 A1
(43) Pub. Date: Oct. 26, 2006

(54) Method and system for albuming multimedia using albuming hints

(75) Inventors: Sangkyun Kim, Yongin-si (KR); Jiyeun Kim, Seoul (KR); Yongman Ro, Daejeon-si (KR); Seungji Yang, Wonju-si (KR)

Correspondence Address: STAAS & HALSEY LLP, SUITE 700, 1201 NEW YORK AVENUE, N.W., WASHINGTON, DC, 20005, US

(73) Assignees: Samsung Electronics Co., Ltd., Suwon-si (KR); Research & Industrial Cooperation Group, Daejeon-si (KR)

(21) Appl. No.: 11/405,566

(22) Filed: Apr. 18, 2006

(30) Foreign Application Priority Data
Apr. 18, 2005 (KR) 10-2005-0032127
Apr. 14, 2006 (KR) 10-2006-0033951

(51) Int. Cl. G06F 17/00; G06K 9/54

(52) U.S. Cl. 382/305; 707/104.1

(57) ABSTRACT

A method and apparatus album multimedia using media albuming hints. The multimedia albuming method includes: extracting albuming hints from multimedia contents; describing the extracted albuming hint information in a predetermined description structure; generating a media descriptor by using the described albuming hint information; and albuming multimedia contents by using the media descriptor. According to the method and apparatus, digital multimedia, such as digital photos, music, and video data (moving pictures), may be albumed automatically or semiautomatically. Also, media albuming hints included in the present method and apparatus may be used such that the performance of albuming functions, such as indexing or clustering with semantic information of multimedia contents, may be enhanced. Furthermore, by reducing the complexity of calculations required for albuming, the albuming may be performed more efficiently.

### CROSS-REFERENCE TO RELATED APPLICATIONS

This application claims the benefit of Korean Patent Application No. 10-2005-0032127, filed on Apr. 18, 2005, and No. 10-2006-0033951, filed on Apr. 14, 2006, in the Korean Intellectual Property Office, the disclosures of which are incorporated herein in their entirety by reference.

### BACKGROUND OF THE INVENTION

1. Field of the Invention

The present invention relates to digital media contents albuming, and more particularly, to a multimedia albuming method and system using media albuming hint information.

2. Description of the Related Art

Elements of multimedia today are switching from an analogue age to a digital age. Accordingly, digital multimedia contents have been rapidly distributed such that digital multimedia contents are now growing as independent media. The elements of digital multimedia contents include letters (txt, hwp, doc, html), images or photos (bmp, wmf, jpg, gif), sound or music (wav, mid, mp3, ogg), moving pictures (avi, mpg, rm, asf, asx, wmv). With the development of communication environments such as the Internet and broadband communication networks, transmission and sharing of contents have become easier and as a result, a huge amount of digital multimedia contents are being produced everyday, and people can easily access digital multimedia contents wherever and whenever they are.

Meanwhile, with the introduction of a small-sized high performance digital camera and/or camcorder, ordinary people have become able to record and edit digital photos or video films of their daily lives. In addition, with the development of music compression technologies, people have become able to receive high quality music files whenever and wherever they are. As the amount of digital multimedia contents have been rapidly increasing, a technology capable of effectively managing the large amount of contents has also been needed. A digital multimedia album is a tool that aids in effectively managing and browsing multimedia contents, such as photos, music, and video.

Ordinary conventional digital multimedia albums include basic functions for a user to add notes (metadata) in characters to multimedia contents, store the multimedia contents in respective folders, and browse multiple multimedia contents stored in an arbitrary folder at one time. However, since multimedia contents include too much information to be expressed in characters, manually generating metadata by a user takes considerable time and may lack accuracy. A result of surveying the functions of photo albums that are required by users has shown that most of users agreed to the necessity of a digital photo album, but felt uncomfortable about the time and effort required to group or label many photos one by one, and experienced much difficulty in sharing photos with others.

To solve the problems of manually generating metadata as described above, many researchers have worked on content-based indexing technologies by which metadata of contents has been automatically generated. In ‘Content-based Image Retrieval at the End of the Early Years’ by Arnold W. M. Smeulders, contents-based retrieval technologies performed in recent years were introduced. One of the leading research efforts for effectively generating and managing metadata for digital multimedia contents is a Moving Picture Experts Group (MPEG)-7. With an aim of establishing a standard interface capable of describing all information of multimedia, MPEG-7 enables the conventional restricted content retrieval method to be expanded. Under the aim, the MPEG group, which is a multimedia standardization group under joint technology committees of the International Standard Organization (ISO) and IEC, which are international standardization organizations, has enacted an MPEG-7 standard in recent years.

MPEG-7 relates to a method of expressing the contents of multimedia.

MPEG-7 may be broken down into content-based retrieval for audio data, including voice or sound information, content-based retrieval for still image data including photos and graphic data, and content-based retrieval for moving pictures, including video data.

Since description information generated by using an MPEG-7 description tool is related to the content itself, it enables fast and effective retrieval and filtering for contents desired by a user. Since MPEG-7 is a standard for a broad range of application fields, it is designed to embrace all factors considered in standard organizations for special application fields, such as Society of Motion Picture Television Engineers (SMPTE), Metadata Dictionary, Dublin Core, EBU P/Meta and TV Anytime. MPEG-7 has employed Extensible Markup Language (XML) to describe contents in characters and to make description tools scalable.

MPEG-7 standardizes element technologies required for content-based retrieval in a description structure to express descriptors and relations between descriptors and description schemes. A method of extracting content-based feature values, such as color, texture, shape, and motion is suggested as a descriptor. The description structure defines the relationship between two or more descriptors and description schemes to model contents, and defines how data is expressed.

MPEG-7 may be used effectively to album multimedia contents. In the albuming of multimedia contents, one of the most important and difficult parts is to automatically extract semantic information of an upper level of the multimedia contents. This semantic information is used to index or cluster (or categorize) multimedia contents into meaningful groups.

However, the performance of the content-based retrieval or indexing still cannot satisfy the requirements of users. For example, in the case of the photo album, ordinary users want to classify and store photos with respect to events or categories.

However, since the semantic concepts such as the events and categories are very high level semantic concepts that are perceived by human-beings, it is very difficult to automatically extract the semantic concepts of this high level due to a significant semantic gap between the semantic concepts of a lower level that may be perceived by a computer and the concepts of events or categories that are higher semantic concepts at the perceptual levels of human beings.

### SUMMARY OF THE INVENTION

The present invention comprises a multimedia albuming method and system using media albuming hint information, by utilizing information related to acquisition of multimedia contents and visual/audio information obtained from the contents of multimedia as albuming hint information.

According to an aspect of the present invention, a multimedia albuming method includes: extracting albuming hints from multimedia contents; describing the extracted albuming hint information in a predetermined description structure; generating a media descriptor by using the described albuming hint information; and albuming multimedia contents by using the media descriptor.

The method may further include: generating album metadata to manage album information of multimedia contents by using an albumed result; and storing albumed multimedia contents and album metadata related to albuming in a database.

The method may further include: obtaining contents from a multimedia content acquisition apparatus and performing preprocessing; and receiving inputs of the multimedia contents and the metadata corresponding to the multimedia contents obtained from the multimedia content obtaining apparatus.

The albuming hint information may include photo albuming hint information, music albuming hint information and video albuming hint information.

The description structure of the photo albuming hint information may include a description structure expressing information on a time when a photo is taken and camera information, a description structure expressing the perceptual characteristic of human beings with respect to the contents of a photo, a description structure expressing information on a person included in a photo, a description structure expressing information on the view of a photo, and a description structure expressing information on the popularity of a photo.

The description structure expressing information on a time when a photo is taken and camera information may include at least one of information indicating whether or not photo data includes Exif information as metadata, photographer information, photographing time information, manufacturer information on the manufacturer of a camera with which a photo is taken, camera model information on the model of a camera with which a photo is taken, shutter speed information on the shutter speed when a photo is taken, color mode information on a color mode when a photo is taken, information indicating sensitivity of film (in the case of a digital camera, an image pickup device, such as a CCD and a CMOS) when a photo is taken, information indicating whether a flash is used when a photo is taken, information indicating the degree of opening of the iris of a camera lens when a photo is taken, information indicating the distance of an optical zoom which is used when a photo is taken, information indicating the focal length when a photo is taken, information indicating the distance between a focused object and the camera when a photo is taken, GPS information in relation to a place where a photo is taken, information indicating the direction in which a first pixel of a photo image is located, as the direction of a camera when a photo is taken, information indicating sound recorded together when a photo is taken, and information indicating a thumbnail image stored for high-speed browsing in a camera after a photo is taken.

The description structure expressing the perceptual characteristic of human beings with respect to the contents of a photo may include at least one of an item (avgColorfulness) indicating the degree of colorful expression of a photo, an item (avgColorCoherence) indicating the degree of coherence of the entire color expressed in a photo, an item (avgLevelOfDetail) indicating the precision of the contents included in a photo, an item (avgHomogenity) indicating homogeneity of texture information of the contents of a photo, an item (avgPowerOfEdge) indicating the robustness of edge information of the contents included in a photo, an item (avgDepthOfField) indicating the depth of the focus of a camera with respect to the contents included in a photo, an item (avgBlurness) indicating the degree of blur of the contents of a photo by a shake occurring when a camera shutter is pressed, an item (avgGlareness) indicating the degree that the contents of a photo are hidden by light when a large quantity of flash light is used to take a photo or an external light source with a large quantity of strong light is used, and an item (avgBrightness) indicating the entire brightness of a photo.

The item (avgColorfulness) indicating the degree of colorful expression of a photo may be measured by normalizing the height of a histogram of each RGB color value from a color histogram and the distribution value of the entire color value, or by using the distribution value of colors measured by using CIE L*u*v* color space.

The item (avgColorCoherence) indicating the degree of coherence of the color expressed in a photo may be measured by using a Dominant Color descriptor among MPEG-7 visual descriptors, and is measured by normalizing the histogram height of each color value from a color histogram and the distribution value of the entire color value.

The item (avgLevelOfDetail) indicating the precision of the contents included in a photo may be measured by using entropy measured from the pixel information of the photo, or by using an isopreference curve that is an element to determine the actual complexity of a photo, or by a relative measuring method in which compression ratios when compression is performed under identical conditions are compared with each other.

The item (avgHomogeneity) indicating homogeneity of texture information of the contents of a photo may be measured using regularity, direction and scale of texture from feature values of a Texture Browsing descriptor among the MPEG-7 visual descriptors.

The item (avgPowerOfEdge) indicating the robustness of edge information of the contents included in a photo may be measured by extracting edge information from a photo and normalizing the strength of the extracted edge.

The item (avgDepthOfField) indicating the depth of the focus of a camera with respect to the contents included in a photo may be measured generally by using the focal length of a camera lens, the diameter of the lens, and figures of the iris.

The item (avgBlurness) indicating the degree of blur of the contents of a photo by a shake occurring when a camera shutter is pressed may be measured using the power of an edge of the contents of the photo.

The item (avgGlareness) indicating the degree that the contents of a photo are hidden by an external light source with a large quantity of strong light may be measured by using the brightness of a photo pixel value.

The item (avgBrightness) indicating the entire brightness of a photo may be measured using the brightness of a photo pixel value.

The description structure expressing information on a person included in a photo may include an item indicating the number of persons included in a photo, an item indicating position information on the position of the face of each person and the position of the clothes worn by the person, and an item indicating the relationships among persons included in a photo.

The item indicating position information on the position of the face of each person and the position of the clothes worn by the person may include an identification of the person, and the position of the clothes worn by the person.

The item indicating the relationships among persons included in a photo may include an item indicating a first person of the two persons whose relationship is to be indicated, an item indicating the second person, and an item indicating the relationship between the two persons.

The description structure expressing information on the view of a photo may include an item indicating whether a major part shown in a photo is a background or a foreground, an item indicating the position of a part corresponding to the background in the contents expressed in a photo, and an item indicating the position of a part corresponding to the foreground in the contents expressed in a photo.

The description structure of the music albuming hint information may include at least one of a description structure expressing information on a time when a music file is recorded, generated or edited, a description structure expressing a part that is a highlight of a music file, a description structure expressing the level of perceptual sound quality of a music file, a description structure expressing information on the mood of music, a description structure expressing information on a situation suitable to reproduce a music file, a description structure expressing media resource information on photos or moving pictures related to a music file, and a description structure expressing popularity or preference of a music file.

In the case of an MP3 file, the description structure expressing information on a time when music is recorded, generated or edited may include at least one of a description structure indicating whether metadata in relation to a music file includes ID3 header information, a description structure indicating the title of a music file, a description structure indicating the name of a singer or player of music, a description structure indicating the genre of music, a description structure indicating the total reproduction time of a music file, a description structure indicating information on the lyrics of music, and a description structure indicating the language of a music file.

The description structure of the video albuming hint information may include a description structure expressing information on major characters included in a video file, a description structure expressing a part that is the highlight of a video file, and a description structure expressing the popularity or preference of a video file.

The described albuming hint information may be used by a media description tool to generate a media descriptor that is metadata to describe media together with content-based feature value metadata.

In the albuming of the multimedia contents, at least one of photo data, music data and video data may be clustered or indexed using the media descriptor.

The clustering or indexing of the photo data may include at least one of: albuming photos based on a situation in which a photo is taken; albuming photos based on a semantic category included in a photo; and albuming photos based on a person included in a photo.

The clustering or indexing of the music data may include at least one of: albuming music based on ID3 metadata, such as the title of a music file, a singer's album, genre, language, and reproduction time; and albuming music based on the mood of a music file.

The clustering or indexing of the video data may include at least one of: albuming video data based on a basic unit shot of a video segment; albuming video data based on a scene having semantic information more than a shot; albuming video data based on a genre of a video file; and albuming based on a person included in a video file

The albuming of the multimedia contents may include at least one of: albuming by using only media albuming hint information; and albuming by combining media albuming hints with content-based feature values.

According to another aspect of the present invention, a multimedia albuming system includes: a media albuming hint description structure providing unit generating a media albuming hint description structure; an albuming hint extraction unit extracting albuming hint information from multimedia contents and describing albuming hints according to the media albuming hint description structure generated by the media albuming hint description structure providing unit; a media description unit generating a media descriptor by using the described albuming hint information; and a media albuming unit albuming multimedia contents by using the media descriptor.

The system may further include: a media album description unit generating album metadata to manage album information of multimedia contents by using an albumed result; and a database storing albumed multimedia contents and album metadata related to albuming in a database.

The system may further include: a media acquisition unit obtaining contents from a multimedia content acquisition apparatus and performing preprocessing; and a media input unit receiving inputs of the multimedia contents and the metadata corresponding to the multimedia contents obtained from the multimedia content obtaining apparatus.

The albuming hint information of the albuming hint extraction unit may include photo albuming hint information, music albuming hint information and video albuming hint information.

The description structure of the photo albuming hint information may include at least one of a description structure expressing information about a time when a photo is taken and camera information, a description structure expressing the perceptual characteristic of human beings with respect to the contents of a photo, a description structure expressing information on a person included in a photo, a description structure expressing information on the view of a photo, and a description structure expressing information on the popularity of a photo.

The description structure of the music albuming hint information may include at least one of a description structure expressing information on a time when a music file is recorded, generated or edited, a description structure expressing a part that is a highlight of a music file, a description structure expressing the level of perceptual sound quality of a music file, a description structure expressing information on the mood of the music, a description structure expressing information on a situation suitable to reproduce a music file, a description structure expressing media resource information on photos or moving pictures related to a music file, and a description structure expressing popularity or preference of a music file.

The description structure of the video albuming hint information may include a description structure expressing information on major characters included in a video file, a description structure expressing a part that is the highlight of a video file, and a description structure expressing the popularity or preference of a video file.

The described albuming hint information may be used by a media description tool to generate a media descriptor that is metadata to describe media together with content-based feature value metadata.

The media albuming unit may include at least one of: a photo data albuming unit clustering or indexing photo data by using the media descriptor; a music data albuming unit clustering or indexing music data by using the media descriptor; a video data albuming unit clustering or indexing video data by using the media descriptor.

The photo data albuming unit may include at least one of: a situation-based photo albuming unit albuming photos based on a situation in which a photo is taken; a category-based photo albuming unit albuming photos based on a semantic category included in a photo; and a person-based photo albuming unit albuming photos based on a person included in a photo.

The music data albuming unit may include at least one of: an ID3-based music albuming unit albuming music based on ID3 metadata including at least one of the title of a music file, a singer's album, genre, language, and reproduction time information; and a mood-based music albuming unit albuming music based on the mood of a music file.

The video data albuming unit may include at least one of: a shot-based video albuming unit albuming video data based on a basic unit shot of a video segment; a scene-based video albuming unit albuming video data based on a scene having semantic information in addition to a shot; a genre-based video albuming unit albuming video data based on a genre of a video file; and a person-based video albuming unit albuming based on a person included in a video file.

The media albuming unit may perform albuming by using only media albuming hint information or by combining media albuming hints with content-based feature values.

According to still another aspect of the present invention, a computer readable recording medium has embodied thereon a computer program for executing the methods.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating a structure of a multimedia albuming system according to an embodiment of the present invention;

FIG. 2 is a flowchart illustrating a multimedia albuming method according to an embodiment of the present invention;

FIG. 3 illustrates an extracted media albuming hint description structure according to an embodiment of the present invention;

FIG. 4 illustrates a photo albuming hint information description structure in detail according to an embodiment of the present invention;

FIG. 5 illustrates in detail a photo acquisition hint description structure to express information about a time when a photo is taken and camera information according to an embodiment of the present invention;

FIG. 6 illustrates in detail a photo perception hint description structure to express perceptual characteristics of the contents of photos perceived by human beings according to an embodiment of the present invention;

FIG. 7 illustrates intuitive feelings generally perceived by human beings when the person sees a photo of an evening glow according to an embodiment of the present invention;

FIG. 8A illustrates in detail a description structure of subject hints expressing information on persons, and FIG. 8B illustrates an example of the position of the face of a person included in a photo and the position of the clothes worn by the person according to an embodiment of the present invention;

FIG. 9A illustrates in detail a description structure of view hints, and FIG. 9B illustrates examples of a foreground and background displayed based on the photo view hints according to an embodiment of the present invention;

FIG. 10 is a block diagram illustrating a hint parameter description structure for albuming multimedia expressed in an XML schema according to an embodiment of the present invention;

FIG. 11 is a block diagram illustrating a hint parameter description structure for albuming photos expressed in an XML schema according to an embodiment of the present invention;

FIG. 12 is a block diagram illustrating a description structure to express information about a time when a photo is taken and camera information expressed in an XML schema according to an embodiment of the present invention;

FIG. 13 is a block diagram illustrating a description structure to express the perceptual characteristics of human beings with respect to the contents of a photo, expressed in an XML schema according to an embodiment of the present invention;

FIG. 14 is a block diagram illustrating a description structure to express information on a person included in a photo expressed in an XML schema according to an embodiment of the present invention;

FIG. 15 illustrates a description structure of music albuming hint information according to an embodiment of the present invention;

FIG. 16 illustrates a description structure to express information on a time when music is recorded, generated or edited according to an embodiment of the present invention;

FIG. 17 is a block diagram illustrating a description structure for hint parameters required for albuming music expressed in an XML schema according to an embodiment of the present invention;

FIG. 18 illustrates a description structure of video albuming hint information according to an embodiment of the present invention;

FIG. 19 is a block diagram illustrating a description structure of hints parameters required for video albuming expressed in an XML schema according to an embodiment of the present invention;

FIG. 20 is a block diagram illustrating a more detailed structure of a media albuming unit according to an embodiment of the present invention;

FIG. 21 is a block diagram illustrating a more detailed structure of a photo data albuming unit 20 according to an embodiment of the present invention;

FIG. 22 is a block diagram illustrating a more detailed structure of a music data albuming unit 22 according to an embodiment of the present invention;

FIG. 23 is a block diagram illustrating a more detailed structure of a video data albuming unit according to an embodiment of the present invention;

FIG. 24 illustrates a structure of an albuming tool according to an embodiment of the present invention;

FIG. 25 illustrates a structure of a photo albuming tool according to an embodiment of the present invention;

FIG. 26 illustrates a structure of a music albuming tool according to an embodiment of the present invention; and

FIG. 27 illustrates a structure of a video albuming tool according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

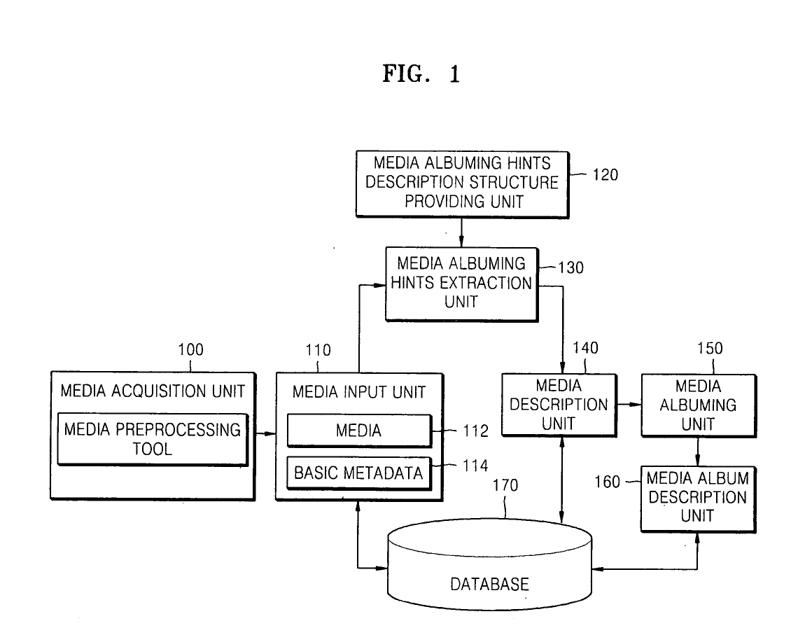

FIG. 1 is a block diagram illustrating a structure of a multimedia albuming system according to an embodiment of the present invention. The multimedia albuming system comprises a media albuming hint description structure providing unit 120, a media albuming hint extraction tool 130, a media description unit 140, and a media albuming unit 150. The multimedia albuming system according to the present invention may further include a media album description unit 160 and a database 170. Also, a media acquisition unit 100 and a media input unit 110 may be further included.

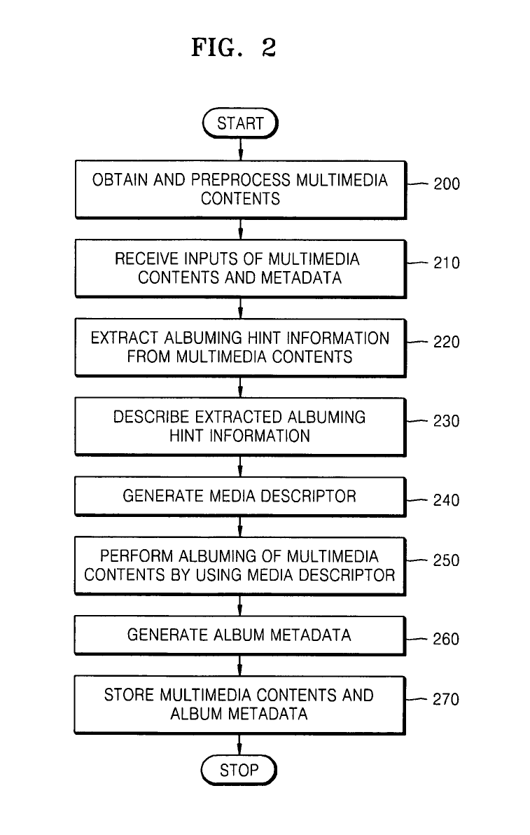

FIG. 2 is a flowchart illustrating a multimedia albuming method according to an embodiment of the present invention. Referring to FIGS. 1 and 2, the structure and operation of the multimedia albuming system and the albuming method according to the present invention will now be explained.

Referring to FIG. 1, the media acquisition unit 100 obtains contents from a multimedia content acquisition apparatus and performs preprocessing in operation 200. The media acquisition unit 100 obtains multimedia data such as photos, music and video data through a digital photographing apparatus or a recording apparatus. The media acquisition unit 100 generates multimedia contents and includes a media preprocessing tool 102 for generating metadata related to media data and media acquisition. Multimedia data and metadata corresponding to the multimedia data obtained through the media acquisition unit 100 are transferred to the media input unit 110.

The media input unit 110 receives inputs of the obtained multimedia contents and the corresponding metadata in operation 210. The media input unit 110 includes media data 112 and also includes basic metadata 114 corresponding to the media data. The basic metadata 114 is metadata which is described when multimedia data is obtained or generated. The basic metadata 114 may include Exif metadata of a JPEG photo file, ID3 metadata of an MP3 music file, metadata related to compression of an MPEG video file, but is not limited to these.

Information on the input media 112 and the basic metadata 114 is transferred to the media albuming hints extraction tool 130 which extracts albuming hint information.

The media albuming hints description structure providing unit 120 provides a media albuming hint description structure.

According to the media albuming hint description structure provided by the media albuming hint description structure providing unit 120, the media albuming hints extraction tool 130 extracts albuming hint information from multimedia contents in operation 220 and describes albuming hints in operation 230. The media albuming hint extraction unit 130 utilizes information, such as information obtained in the process of acquiring multimedia data, which may be obtained easily but may play a vital role in the process of albuming, as hint information in the albuming. By doing so, the performance of an albuming function in which multimedia contents are indexed or clustered according to semantic information included in the contents, may be enhanced and the complexity of calculation required for albuming may be reduced, such that albuming can be performed more quickly.

Thus, FIG. 2 illustrates a multimedia albuming method according to an embodiment of the present invention that includes the operations: obtaining and preprocessing multimedia contents 200, receiving inputs of multimedia contents and metadata 210, extracting albuming hint information from multimedia contents 220, describing extracted albuming hint information 230, generating media descriptor 240, performing albuming of multimedia contents by using media descriptor 250, generating album metadata 260, and storing multimedia contents and album metadata 270.

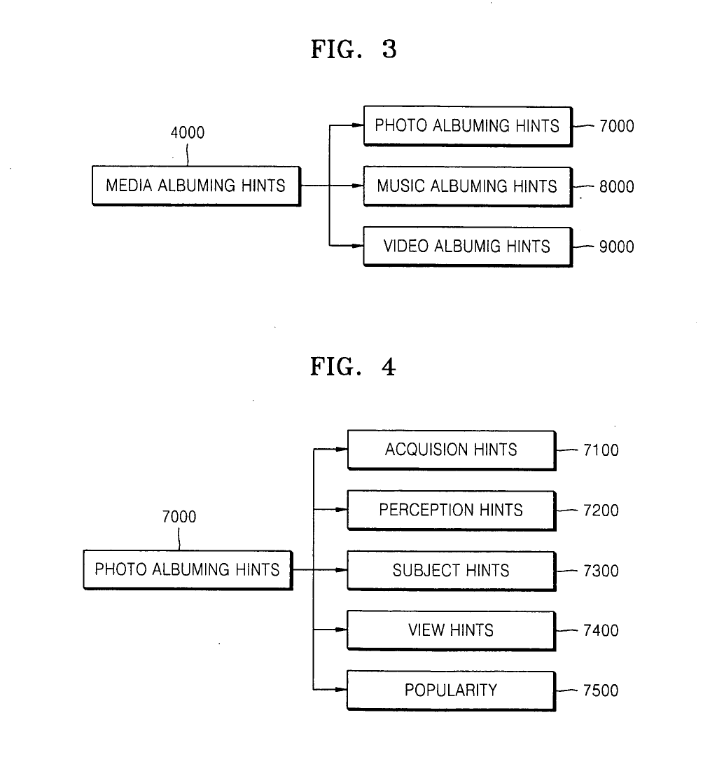

FIG. 3 illustrates a media albuming hint description structure extracted using the media albuming hint tool 130 according to an embodiment of the present invention. Referring to FIG. 3, the media albuming hint description structure 4000 includes an albuming hint information description structure for image media such as photos (Photo Albuming Hints) 7000, an albuming hint information description structure for audio media such as music (Music Albuming Hints) 8000, and an albuming hint information description structure for video media such (Video Albuming Hints) 9000.

FIG. 4 illustrates the photo albuming hint information description structure 7000 in detail according to an embodiment of the present invention. Referring to FIG. 4, the photo albuming hint information description structure 7000 may include: a description structure (Acquisition Hints) 7100 to express information on a time when a photo is taken and camera information, a description structure (Perception Hints) 7200 to express the perceptual characteristic of human beings with respect to the contents of a photo, a description structure (Subject Hints) 7300 to express information on a person included in a photo, a description structure (View Hints) 7400 to express information on the view of a photo, and a description structure (Popularity) 7500 to express information on the popularity of a photo.

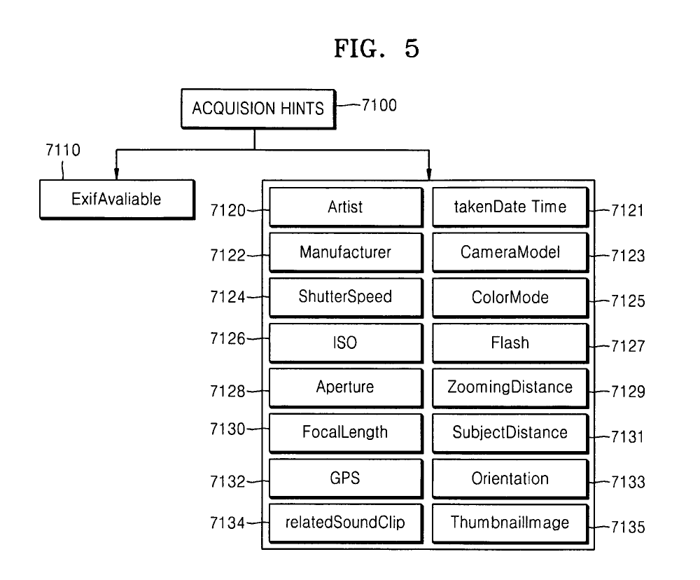

FIG. 5 illustrates in detail the photo acquisition hint description structure 7100 to express information about a time when a photo is taken and camera information according to an embodiment of the present invention. Referring to FIG. 5, the photo acquisition hint description structure 7100 includes basic photographing information and camera information that may be used in the albuming of photos. Generally, photo data is compressed in a JPEG format, and in the JPEG file, Exif information includes photographing information about a time when a photo is taken and camera setting information. The metadata may help enhancement of photo indexing performance.

The photo acquisition hint description structure 7100 may include information (ExifAvailable) 7110 indicating whether the photo data includes Exif information as metadata; photographer information (Artist) 7120 of a photographer who takes a photograph; time information (takenDateTime) 7121 about a time when a photo is taken; manufacturer information (Manufacturer) 7122 on a manufacturer of a camera with which a photo is taken; camera model information (CameraModel) 7123 on the model of a camera with which a photo is taken; shutter speed information (ShutterSpeed) 7124 on the shutter speed when a photo is taken; color mode information (ColorMode) 7125 on a color mode when a photo is taken; information (ISO) 7126 indicating sensitivity of film (in case of a digital camera, an image pickup device, such as a CCD and a CMOS) when a photo is taken; information (Flash) 7127 indicating whether a flash is used when a photo is taken; information (Aperture) 7128 indicating the degree of the opening of the iris of a camera lens when a photo is taken; information (ZoomingDistance) 7129 indicating the distance of an optical zoom which is used when a photo is taken; information (FocalLength) 7130 indicating the focal length when a photo is taken; information (SubjectDistance) 7131 indicating the distance between a focused object and the camera when a photo is taken; GPS information (GPS) 7132 in relation to a place where a photo is taken; information (Orientation) 7133 indicating the direction in which a first pixel of a photo image is located, as the direction of a camera when a photo is taken; information (relatedSoundClip) 7134 indicating sound recorded together when a photo is taken; and information (ThumbnailImage) 7135 indicating a thumbnail image stored for high-speed browsing in a camera after a photo is taken.

The information exists in Exif metadata, and may be used effectively for photo albuming. If a photo file includes Exif metadata, more information may be used, but a photo file may not include Exif metadata, and important metadata is described as photo albuming hints. Elements of the photo acquisition hint description structure 7100 include the major elements described above, but are not limited to these.

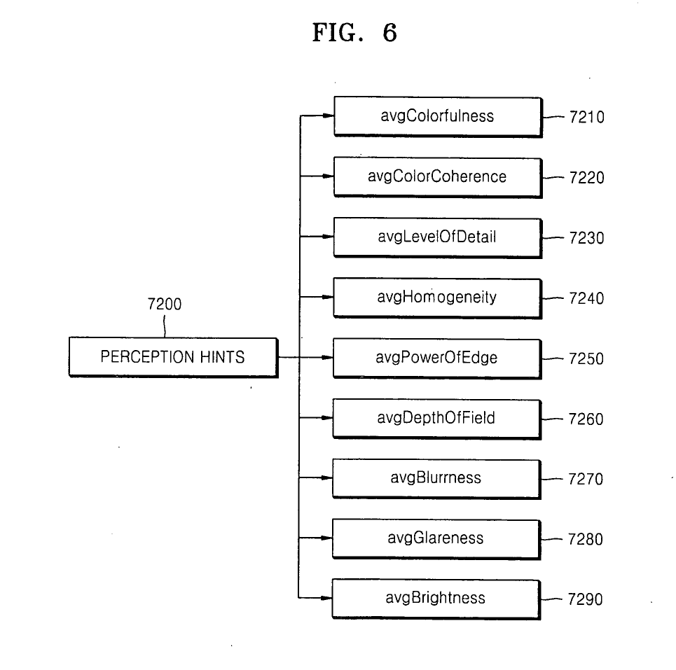

FIG. 6 illustrates, in detail, the photo perception hint description structure 7200 to express perceptual characteristics of the contents of photos perceived by human beings according to an embodiment of the present invention. Referring to FIG. 6, the photo perception hint description structure 7200 is a description structure expressing information on the perceptual characteristics of human beings and includes information on the characteristic that human beings have when perceiving the contents of a photo intuitively. This is based on a feeling that is generally felt strongly by human beings when they see a photo.

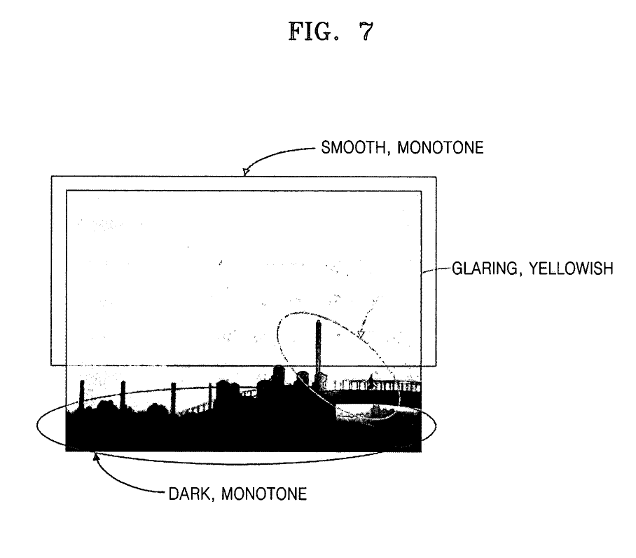

FIG. 7 illustrates intuitive feelings generally perceived by human beings when the person sees a photo of an evening glow according to an embodiment of the present invention. In FIG. 7, the bottom part is very dark and monotonous, the top part is reddish and monotonous, and the middle part is relatively bright and yellowish. As a whole, the photo is very monotonous, and a few colors give a strong impression. If a person compares an arbitrary two photos, and the intuitive feelings of the two photos are similar, the person would feel that the two photos are similar. That is, the strongest characteristic information existing in a photo is felt similarly.

This perceptual characteristic information may play an important role in setting the importance degree of each feature value when photos are albumed using multiple contents-based feature values.

Referring to FIG. 6, the perceptual hint description structure 7200 includes an item (avgColorfulness) 7210 indicating the degree of colorful expression of a photo; an item (avgColorCoherence) 7220 indicating the degree of coherence of the entire color expressed in a photo; an item (avgLevelOfDetail) 7230 indicating the precision of the contents included in a photo; an item (avgHomogenity) 7240 indicating homogeneity of texture information of the contents of a photo; an item (avgPowerOfEdge) 7250 indicating the robustness of edge information of the contents included in a photo; an item (avgDepthOfField) 7260 indicating the depth of the focus of a camera with respect to the contents included in a photo; an item (avgBlurness) 7270 indicating the degree of blur of the contents of a photo by a shake occurring when a camera shutter is pressed; an item (avgGlareness) 7280 indicating the degree that the contents of a photo are hidden by light when a large quantity of flash light is used to take a photo or an external light source with a large quantity of strong light is used; and an item (avgBrightness) 7290 indicating the entire brightness of a photo.

The item (avgColorfulness) 7210 indicating the degree of colorful expression of a photo may be measured by normalizing the height of a histogram of each RGB color value from a color histogram and the distribution value of the entire color value, or by using the distribution value of colors measured by using CIE L*u*v* color space. However, the method of measuring the item (avgColorfulness) 7210 indicating the degree of colorful expression is not limited to these methods.

The item (avgColorCoherence) 7220 indicating the degree of coherence of the color expressed in a photo may be measured by using a Dominant Color descriptor among MPEG-7 visual descriptors, and may be measured by normalizing the histogram height of each color value from a color histogram and the distribution value of the entire color value. However, the method of measuring the item (avgColorCoherence) 7220 is not limited to these methods.

The item (avgLevelOfDetail) 7230 indicating the precision of the contents included in a photo may be measured by using entropy measured from the pixel information of the photo, or by using an ‘isopreference curve’ that is an element to determine the actual complexity of a photo, or by a relative measuring method in which compression ratios when compression is performed under identical conditions (size of an image, quantization steps, and the like) are compared with each other. However the method of measuring the item (avgLevelOfDetail) 7230 is not limited to these methods.

The item (avgHomogeneity) 7240 indicating homogeneity of texture information of the contents of a photo may be measured using regularity, direction and scale of texture from feature values of a Texture Browsing descriptor among the MPEG-7 visual descriptors. However, the method of measuring the item (avgHomogeneity) 7240 is not limited to these methods.

The item (avgPowerOfEdge) 7250 indicating the robustness of edge information of the contents included in a photo may be measured by extracting edge information from a photo and normalizing the strength of the extracted edge. However, the method of measuring the item (avgPowerOfEdge) 7250 is not limited to these methods.

The item (avgDepthOfField) 7260 indicating the depth of the focus of a camera with respect to the contents included in a photo may be measured generally by using the focal length of a camera lens, the diameter of the lens, and figures of the iris. However, the method of measuring the item (avgDepthOfField) 7260 is not limited to these methods.

The item (avgBlurness) 7270 indicating the degree of blur of the contents of a photo by a shake occurring when a camera shutter is pressed may be measured using the power of an edge of the contents of the photo. However, the method of measuring the item (avgBlurness) 7270 is not limited to this method.

The item (avgGlareness) 7280 indicating the degree that the contents of a photo are hidden by an external light source with a large quantity of strong light is a value indicating that a photo is taken under a light source brighter than a reference level in part or all areas of the photo (a case of excessive exposure), and may be measured using the brightness of a photo pixel value. However, the method of measuring the item (avgGlareness) 7280 is not limited to this method.

The item (avgBrightness) 7290 indicating the entire brightness of a photo may be measured using the brightness of a photo pixel value. However, the method of measuring the item (avgBrightness) 7290 is not limited to this method.

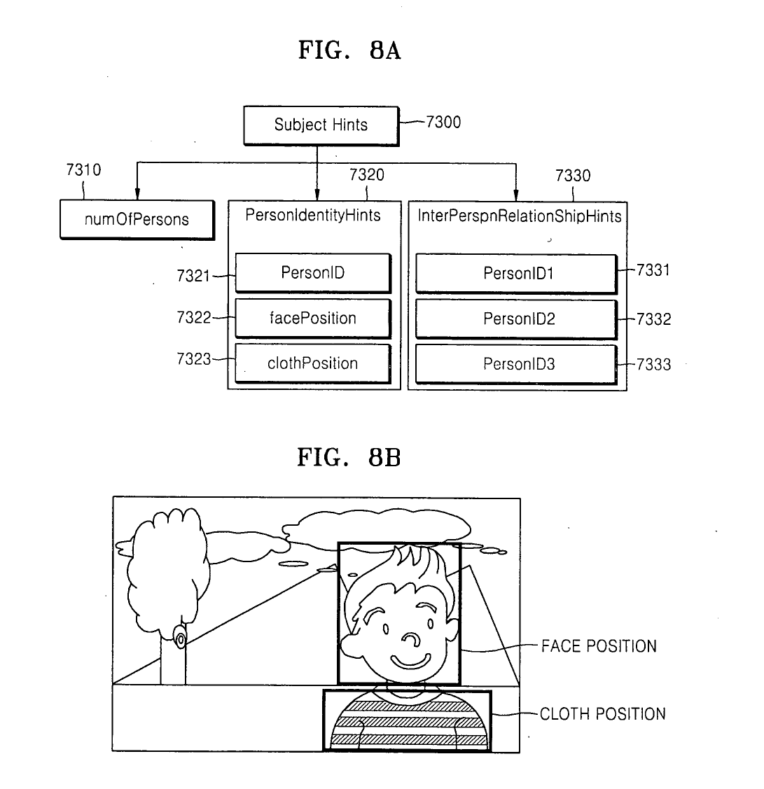

FIG. 8A illustrates in detail the description structure of subject hints (Subjects Hints) 7300 expressing information on persons.

Referring to FIG. 8A, the subject hints 7300 may include an item (numOfPersons) 7310 indicating the number of persons included in a photo, an item (PersonIdentityHints) 7320 indicating position information on the position of the face of each person and the position of the clothes worn by the person, and an item (InterPersonRelationshipHints) 7330 indicating the relationships among persons included in a photo.

The item (PersonIdentityHints) 7320 indicating position information on the position of the face of each person and the position of the clothes worn by the person includes an ID (PersonID) 7321 of the person, a position of the face (facePosition) 7322, and the position (clothPosition) 7323 of the clothes worn by the person. FIG. 8B illustrates an example of the position of the face of a person included in a photo and the position of the clothes worn by the person according to an embodiment of the present invention.

The item (InterPersonRelationshipHints) 7330 indicating the relationships among persons included in a photo includes an item (PersonID1) 7331 indicating a first person of the two persons whose relationship is to be indicated, an item (PersonID2) 7332 indicating the second person, and an item (Relation) 7333 indicating the relationship between the two persons.

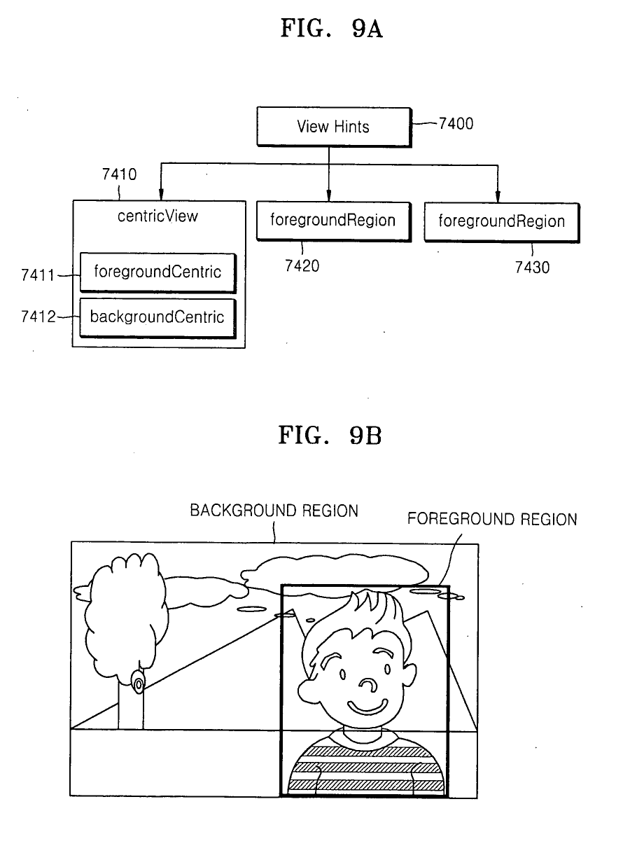

FIG. 9A illustrates in detail the description structure of view hints 7400, and FIG. 9B illustrates examples of a foreground and background displayed based on the photo view hints according to an embodiment of the present invention. Referring to FIG. 9A, the view hints 7400 may include an item (centricView) 7410 indicating whether a major part shown in a photo is a background (backgroundCentric) 7412 or a foreground (foregroundCentric) 7411, an item (foregroundRegion) 7420 indicating the position of a part corresponding to the foreground in the contents expressed in a photo, and an item (backgroundRegion) 7430 indicating the position of a part corresponding to the background in the contents expressed in a photo.

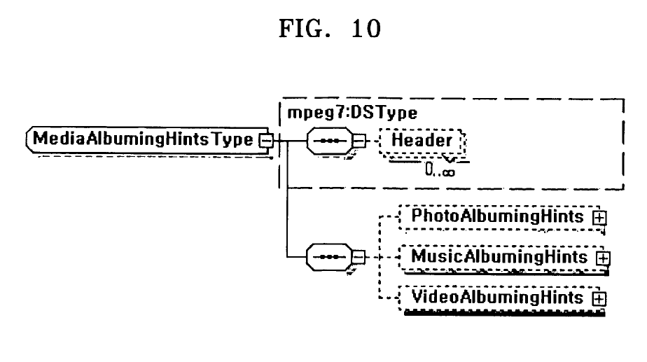

A description structure to express the hint parameters required for effective multimedia albuming described above is expressed in an XML format in the following Table 1. FIG. 10 is a block diagram illustrating a hint parameter description structure for albuming multimedia expressed in an XML schema according to an embodiment of the present invention.

TABLE 1

```
<complexType name=“MediaAlbumingHintsType”>
    <complexContent>
        <extension base=“mpeg7:DSType”>
            <sequence>
                <element name=“PhotoAlbumingHints”
type=“mpeg7:PhotoAlbumingHintsType” minOccurs=“0”/>
                <element name=“MusicAlbumingHints”
type=“mpeg7:MusicAlbumingHintsType” minOccurs=“0”/>
                <element name=“VideoAlbumingHints”
type=“mpeg7:VideoAlbumingHintsType” minOccurs=“0”/>
            </sequence>
        </extension>
    </complexContent>
</complexType>
```

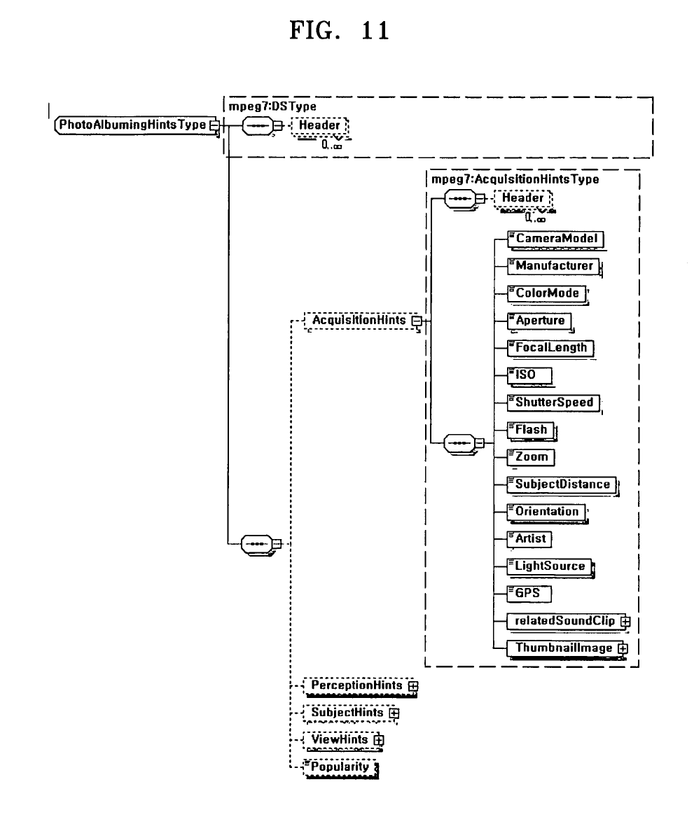

A description structure to express the hint parameters required for photo albuming among the hint parameters required for effective multimedia albuming described above is expressed in an XML format in the following Table 2. FIG. 11 is a block diagram illustrating a hint parameter description structure for albuming photos expressed in an XML schema according to an embodiment of the present invention.

TABLE 2

```
<complexType name=“PhotoAlbumingHintsType”>
    <complexContent>
        <extension base=“mpeg7:DSType”>
            <sequence>
                <element name=“AcquisitionHints”
type=“mpeg7:AcquisitionHintsType” minOccurs=“0”/>
                <element name=“PerceptionHints”
type=“mpeg7:PerceptionHintsType” minOccurs=“0”/>
                <element name=“SubjectHints”
type=“mpeg7:SubjectHintsType” minOccurs=“0”/>
                <element name=“ViewHints”
type=“mpeg7:ViewHintsType” minOccurs=“0”/>
                <element name=“Popularity”
type=“mpeg7:zeroToOneType” minOccurs=“0”/>
            </sequence>
        </extension>
    </complexContent>
</complexType>
```

A description structure to express information on a time when a photo is taken and camera information among the hint parameters required for effective photo albuming described above is expressed in an XML format in the following Table 3.

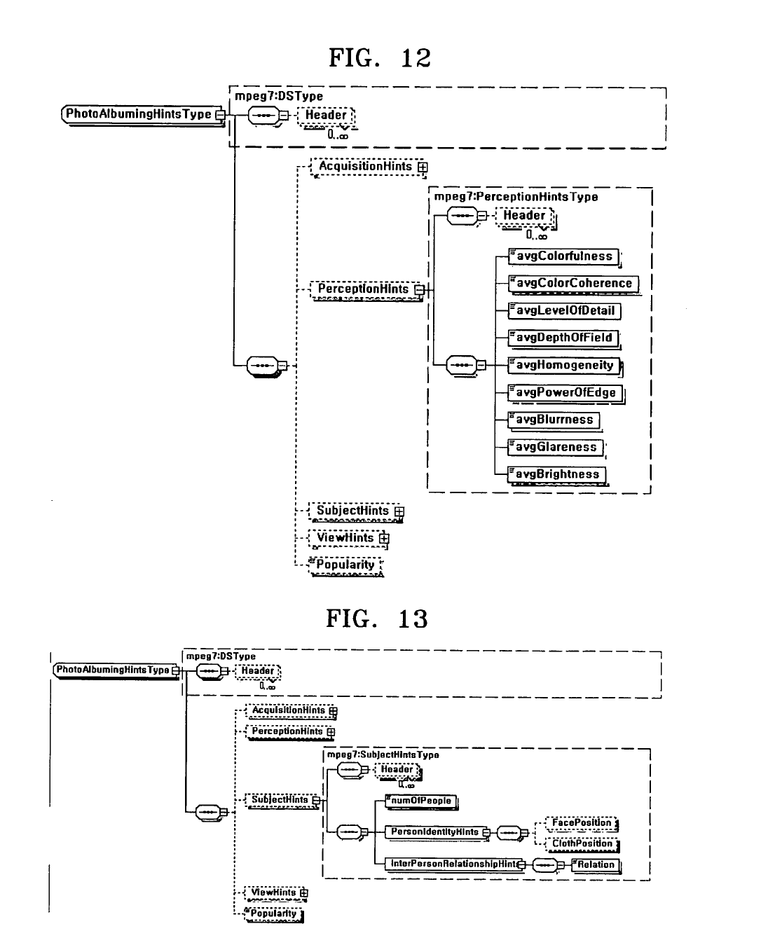

FIG. 12 is a block diagram illustrating a description structure to express information on a time when a photo is taken and camera information expressed in an XML schema according to an embodiment of the present invention.

```
TABLE 3
<complexType name=“AcquisitionHintsType”>
    <complexContent>
        <extension base=“mpeg7:DSType”>
            <sequence>
                <element name=“CameraModel”
type=“mpeg7:TextualType”/>
                <element name=“Manufacturer”
type=“mpeg7:TextualType”/>
                <element name=“ColorMode”
type=“mpeg7:TextualType”/>
                <element name=“Aperture”
type=“nonNegativeInteger”/>
                <element name=“FocalLength”
type=“nonNegativeInteger”/>
                <element name=“ISO” type=“nonNegativeInteger”/>
                <element name=“ShutterSpeed”
type=“nonNegativeInteger”/>
                <element name=“Flash” type=“boolean”/>
                <element name=“Zoom” type=“nonNegativeInteger”/>
                <element name=“SubjectDistance”
type=“nonNegativeInteger”/>
                <element name=“Orientation”
type=“mpeg7:TextualType”/>
                <element name=“Artist” type=“mpeg7:TextualType”/>
                <element name=“LightSource”
type=“mpeg7:TextualType”/>
                <element name=“GPS” type=“mpeg7:TextualType”/>
                <element name=“relatedSoundClip”
type=“mpeg7:MediaLocatorType”/>
                <element name=“ThumbnailImage”
type=“mpeg7:MediaLocatorType”/>
            </sequence>
            <attribute name=“ExifAvailable” type=“boolean”
use=“optional”/>
        </extension>
    </complexContent>
</complexType>
```

A description structure to express information on the perceptual characteristics of human beings with respect to the contents of a photo among the hint parameters required for effective photo albuming described above is expressed in an XML format in the following Table 4. FIG. 13 is a block diagram illustrating a description structure to express the perceptual characteristics of human beings with respect to the contents of a photo, expressed in an XML schema according to an embodiment of the present invention.

TABLE 4

```
<complexType name=“PerceptionHintsType”>
    <complexContent>
        <extension base=“mpeg7:DSType”>
            <sequence>
                <element name=“avgColorfulness”
type=“mpeg7:zeroToOneType”/>
                <element name=“avgColorCoherence”
type=“mpeg7:zeroToOneType”/>
                <element name=“avgLevelOfDetail”
type=“mpeg7:zeroToOneType”/>
                <element name=“avgDepthOfField”
type=“mpeg7:zeroToOneType”/>
                <element name=“avgHomogeneity”
type=“mpeg7:zeroToOneType”/>
                <element name=“avgPowerOfEdge”
type=“mpeg7:zeroToOneType”/>
                <element name=“avgBlurrness”
type=“mpeg7:zeroToOneType”/>
                <element name=“avgGlareness”
type=“mpeg7:zeroToOneType”/>
                <element name=“avgBrightness”
type=“mpeg7:zeroToOneType”/>
            </sequence>
        </extension>
    </complexContent>
</complexType>
```

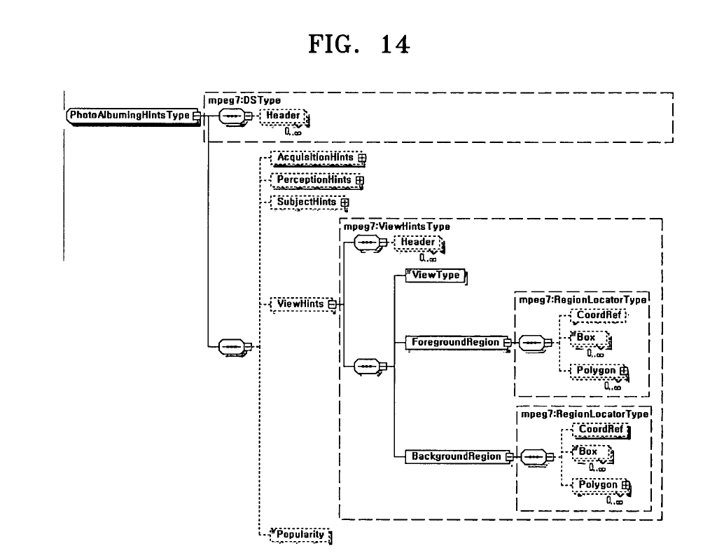

A description structure to express information on a person included in a photo among the hint parameters required for effective photo albuming described above is expressed in an XML format in the following Table 5. FIG. 14 is a block diagram illustrating a description structure to express information on a person included in a photo expressed in an XML schema according to an embodiment of the present invention.

```
TABLE 5
<complexType name=“SubjectHintsType”>
  <complexContent>
    <extension base=“mpeg7:DSType”>
      <sequence>
        <element name=“numOfPeople” type=“nonNegativeInteger”/>
          <element name=“PersonIdentityHints”>
            <complexType>
              <complexContent>
                <extension base=“mpeg7:DType”>
                  <sequence>
                    <element name=“FacePosition” minOccurs=“0”>
                      <complexType>
                          <attribute name=“xLeft” type=“nonNegativeInteger”
use=“required”/>
                          <attribute name=“xRight” type=“nonNegativeInteger”
use=“required”/>
                          <attribute name=“yDown” type=“nonNegativeInteger”
use=“required”/>
                          <attribute name=“yUp” type=“nonNegativeInteger” use=“required”/>
                      </complexType>
                    </element>
                    <element name=“ClothPosition” minOccurs=“0”>
                      <complexType>
                          <attribute name=“xLefft” type=“nonNegativeInteger”
use=“required”/>
                          <attribute name=“xRight” type=“nonNegativeInteger”
use=“required”/>
                          <attribute name=“yDown” type=“nonNegativeInteger”
use=“required”/>
                          <attribute name=“yUp” type=“nonNegativeInteger” use=“required”/>
                                      </complexType>
                    </element>
                  </sequence>
                    <attribute name=“PersonID” type=“IDREF” use=“optional”/>
                </extension>
                </complexContent>
              </complexType>
            </element>
            <element name=“InterPersonRelationshipHints”>
              <complexType>
                <complexContent>
                  <extension base=“mpeg7:DType”>
                      <sequence>
                        <element name=“Relation” type=“mpeg7:TextualType”/>
                      </sequence>
                      <attribute name=“PersonID1” type=“IDREF” use=“required”/>
                      <attribute name=“PersonID2” type=“IDREF” use=“required”/>
                    </extension>
                  </complexContent>
                </complexType>
                </element>
```

A description structure to express information on the view of a photo among the hint parameters required for effective photo albuming described above is expressed in an XML format in the following Table 5.

TABLE 6

```
<complexType name=“ViewHintsType”>
    <complexContent>
        <extension base=“mpeg7:DSType”>
            <sequence>
                <element name=“ViewType”>
                    <simpleType>
                        <restriction base=“string”>
                            <enumeration
value=“closeUpView”/>
                            <enumeration
value=“perspectiveView”/>
                        </restriction>
                    </simpleType>
                </element>
                <element name=“ForegroundRegion”
type=“mpeg7:RegionLocatorType”/>
                <element name=“BackgroundRegion”
type=“mpeg7:RegionLocatorType”/>
            </sequence>
        </extension>
    </complexContent>
</complexType>
```

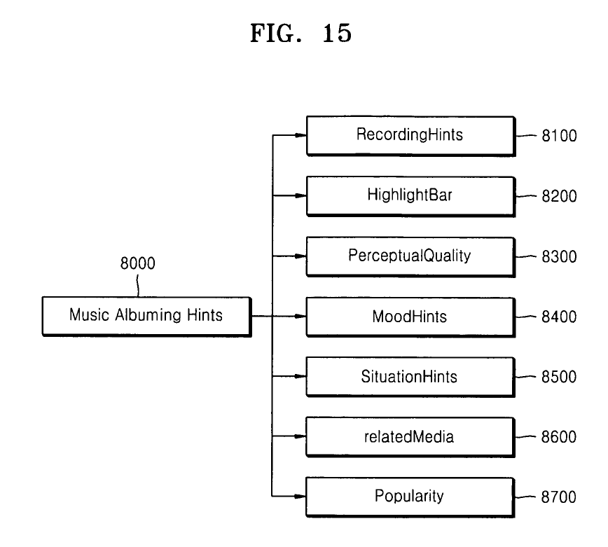

FIG. 15 illustrates in detail the music albuming hint information description structure (Music Albuming Hints) 8000 described above. Referring to FIG. 15, the music albuming hint information description structure 8000 includes a description structure (RecordingHints) 8100 to express information about a time when a music file is recorded, generated or edited; a description structure (HighlightBar) 8200 to express a part that is a highlight of a music file; a description structure (PerceptualQuality) 8300 to express the level of perceptual sound quality of a music file; a description structure (MoodHints) 8400 to express information on the mood of music; a description structure (SituationHints) 8500 to express information on a situation suitable to reproduce a music file; a description structure (relatedMedia) 8600 to express media resource information on photos or moving pictures related to a music file; and a description structure (Polpularity) 8700 to express popularity or preference of a music file.

FIG. 16 illustrates in detail the description structure (RecordingHints) 8100 to express information on a time when music is recorded, generated or edited according to an embodiment of the present invention. Referring to FIG. 16, in case of an MP3 file, the description structure (RecordingHints) 8100 to express information on a time when music is recorded, generated or edited includes a description structure (ID3Available) 8110 indicating whether metadata in relation to a music file includes ID3 header information; a description structure (Title) 8120 indicating the title of a music file; a description structure (Artist) 8130 indicating the name of a singer or player of music; a description structure (Album) 8140 indicating the album; a description structure (Genre) 8150 indicating the genre of music; a description structure (PlayingTime) 8160 indicating the total reproduction time of a music file; a description structure (Lyrics) 8170 indicating information on the lyrics of music; and a description structure (Language) 8180 indicating the language of a music file. However, the description structure to express information on a time when music is recorded, generated or edited is not limited to these.

In the description structure (HighlightBar) 8200 to express a part that is a highlight of a music file, an interval corresponding to the most important part of the music file is expressed with respect to time.

In the description structure (PerceptualQuality) 8300 to express the level of perceptual sound quality of a music file, the subjective level of sound quality of a music file is expressed in a normalized number.

The description structure (MoodHints) 8400 to express information on the mood of music is a description structure to express information on the mood (mood) of music, and express feelings, such as silence, graveness, brightness, lightness, love, happiness, yearning, departure, break, pleasure, and celebration.

The description structure (SituationHints) 8500 to express information on a situation suitable to reproduce a music file expresses information on situations with respect to weather (a sunny day, a cloudy day, a rainy day, a snowy day) or situations with respect to place (home, office, travel, beach, mountain, driving, club, restaurant).

The description structure (relatedMedia) 8600 to express media resource information on photos or moving pictures related to a music file expresses information on photos (a singer's poster, an album jacket photo, and the like) or moving pictures (music video, singer's interview film, and the like) related to the music file.

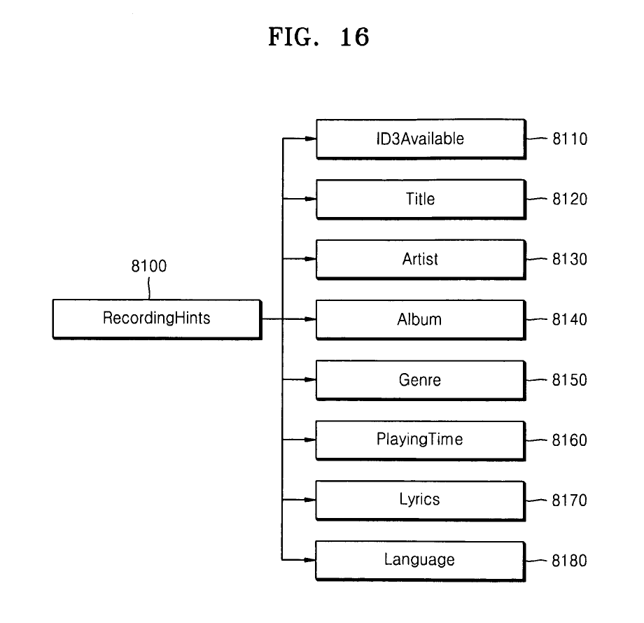

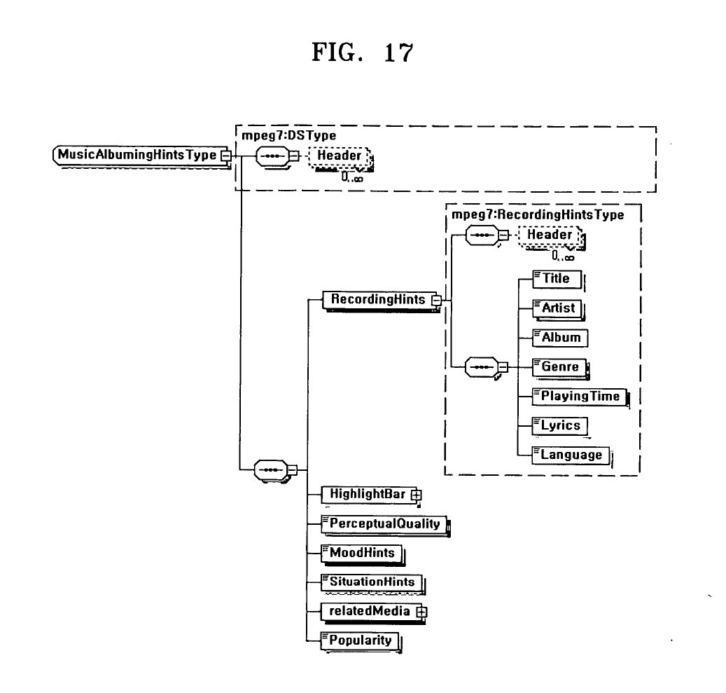

Hint parameters required for the effective music albuming are expressed in an XML format in the following Table 7, and FIG. 17 is a block diagram illustrating a description structure for hint parameters required for music albuming expressed in an XML schema according to an embodiment of the present invention.

```
TABLE 7
<complexType name=“MusicAlbumingHintsType”>
    <complexContent>
        <extension base=“mpeg7:DSType”>
            <sequence>
                <element name=“RecordingHints”
type=“mpeg7:RecordingHintsType”/>
                <element name=“HighlightBar”
type=“mpeg7:TemporalSegmentLocatorType”/>
                <element name=“PerceptualQuality”
type=“mpeg7:zeroToOneType”/>
                <element name=“MoodHints”
type=“mpeg7:TextualType”/>
                <element name=“SituationHints”
type=“mpeg7:TextualType”/>
                <element name=“relatedMedia”
type=“mpeg7:MediaLocatorType”/>
                <element name=“Popularity”
type=“mpeg7:zeroToOneType”/>
            </sequence>
        </extension>
    </complexContent>
</complexType>
<complexType name=“RecordingHintsType”>
    <complexContent>
        <extension base=“mpeg7:DSType”>
            <sequence>
                <element name=“Title” type=“mpeg7:TextualType”/>
                <element name=“Artist” type=“mpeg7:TextualType”/>
                <element
                name=“Album” type=“mpeg7:TextualType”/>
                <element
                name=“Genre” type=“mpeg7:TextualType”/>
                <element name=“PlayingTime”
type=“mpeg7:timePointType”/>
                <element
                name=“Lyrics” type=“mpeg7:TextualType”/>
                <element name=“Language”
type=“mpeg7:TextualType”/>
            </sequence>
            <attribute name=“ID3Available” type=“boolean”
use=“optional”/>
        </extension>
    </complexContent>
</complexType>
```

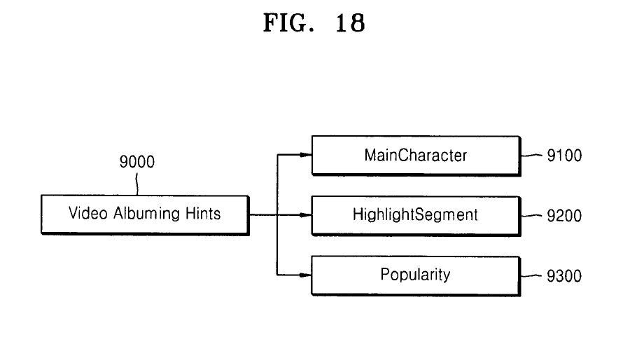

FIG. 18 illustrates the video albuming hint information description structure 9000 according to an embodiment of the present invention. Referring to FIG. 18, the video albuming hint information description structure (Video Albuming Hints) 9000 includes a description structure (MainCharacter) 9100 to express information on major characters included in a video file, a description structure (HighlightSegment) 9200 to express a part that is the highlight of a video file, and a description structure (Popularity) 9300 to express the popularity or preference of a video file.

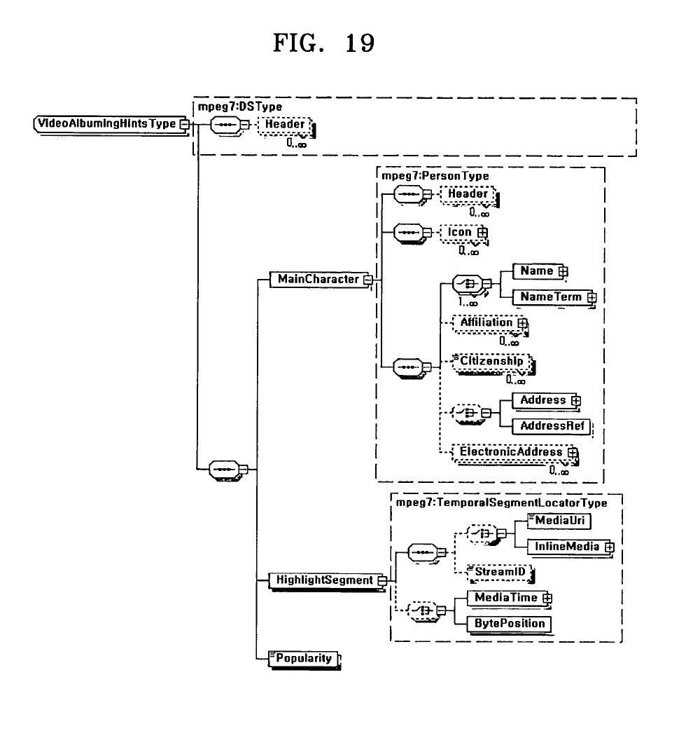

The hint parameters for effective video albuming are expressed in an XML format in the following Table 8, and FIG. 19 is a block diagram illustrating a description structure of hints parameters required for video albuming expressed in an XML schema according to an embodiment of the present invention.

TABLE 8

```
<complexType name=“VideoAlbumingHintsType”>
    <complexContent>
        <extension base=“mpeg7:DSType”>
            <sequence>
                <element name=“MainCharacter”
type=“mpeg7:PersonType”/>
                <element name=“HighlightSegment”
type=“mpeg7:TemporalSegmentLocatorType”/>
                <element name=“Popularity”
type=“mpeg7:zeroToOneType”/>
            </sequence>
        </extension>
    </complexContent>
</complexType>
```

The media description unit 140 generates a media descriptor by using the described albuming hint information. That is, the described albuming hints are transferred to the media description unit 140 such that a media descriptor that is metadata describing media together with other metadata, such as content-based feature value metadata, is generated by a media description tool in operation 240.

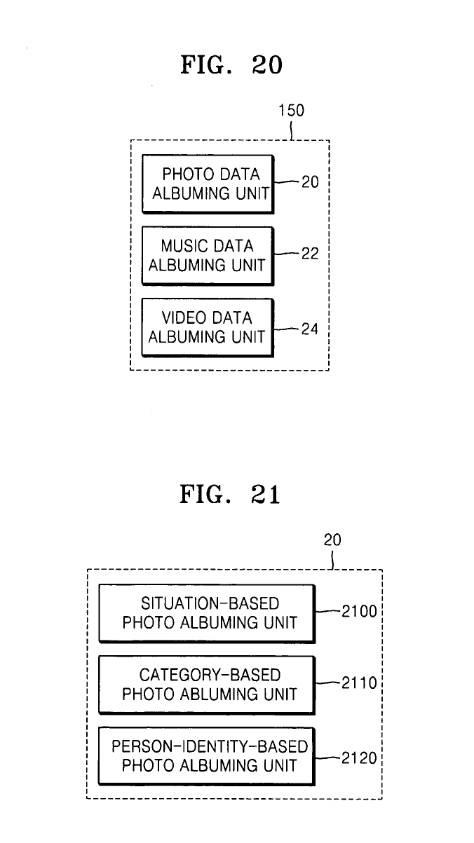

The media albuming unit 150 albums multimedia contents by using the media descriptor in operation 250, and is composed of a photo data albuming unit 20, a music data albuming unit 22, and a video data albuming unit 24 as illustrated in FIG. 20. The photo data albuming unit 20 clusters or indexes photo data by using the media descriptor, and is composed of a situation-based photo albuming unit 2100 for albuming photos based on a situation in which a photo is taken, a category-based photo albuming unit 2110 for albuming photos based on a semantic category included in a photo, and a person-based photo albuming unit 2120 for albuming photos based on a person included in a photo, as illustrated in FIG. 21.

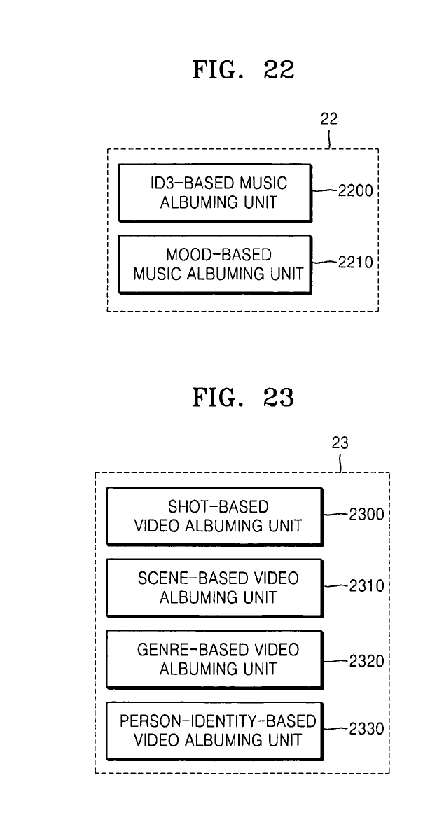

The music data albuming unit 22 clusters or indexes music data by using the media descriptor, and is composed of an ID3-based music albuming unit 2200 for albuming music based on ID3 metadata including at least one of the title of a music file, a singer's album, genre, language, and reproduction time information, and a mood-based music albuming unit 2210 for albuming music based on the mood of a music file, as illustrated in FIG. 22.

The video data albuming unit 23 clusters or indexes video data by using the media descriptor, and is composed of a shot-based video albuming unit 2300 for albuming video data based on a basic unit shot of a video segment, a scene-based video albuming unit 2310 for albuming video data based on a scene having semantic information in addition to a shot, a genre-based video albuming unit 2320 for albuming video data based on a genre of a video file, and a person-identity-based video albuming unit 2330 for albuming based on a person included in a video file, as illustrated in FIG. 23.

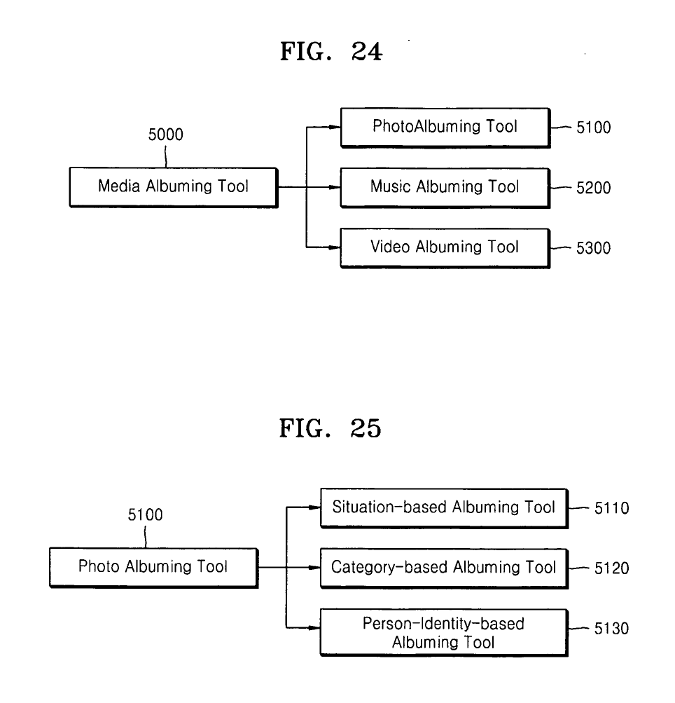

When the media albuming unit 150 is implemented as software, a media albuming tool for albuming multimedia by using a media descriptor may be included. FIG. 24 illustrates a structure of the albuming tool 5000 according to an embodiment of the present invention. Referring to FIG. 24, the albuming tool 5000 for albuming multimedia may be composed of a photo albuming tool 5100 for clustering or indexing photo data, a music albuming tool 5200 for clustering or indexing music data, and a video albuming tool 5300 for clustering or indexing video data.

FIG. 25 illustrates a structure of the photo albuming tool 5100 for albuming photo data according to an embodiment of the present invention. Referring to FIG. 25, the photo albuming tool 5100 for albuming photo data may be composed of a situation-based albuming tool 5110 for albuming photos based on a situation in which a photo is taken, a category-based albuming tool 5120 for albuming photos based on a semantic category (mountain, sea, building, and the like) included in a photo, and a person-identity-based albuming tool 5130 for albuming photos based on a person included in a photo.

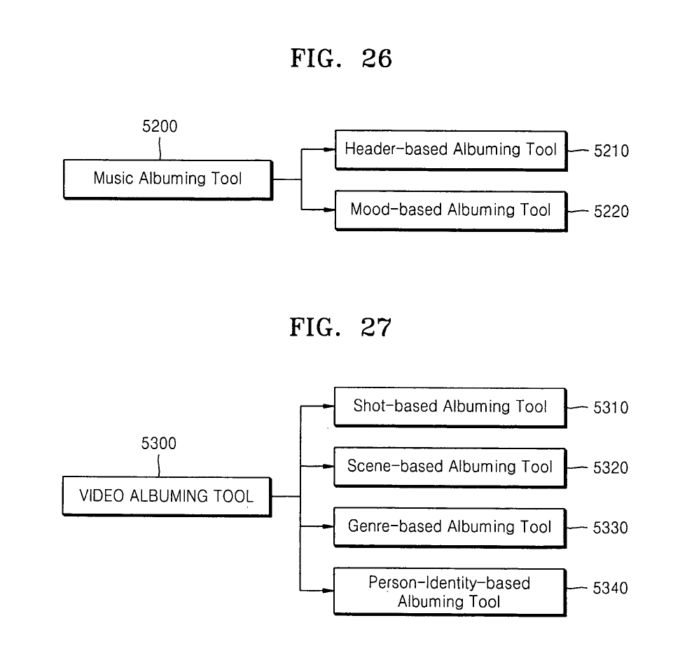

FIG. 26 illustrates a structure of the music albuming tool 5200 for albuming music according to an embodiment of the present invention. Referring to FIG. 26, the music albuming tool 5200 for albuming music data may be composed of a header-based albuming tool 5210 for albuming music based on ID3 metadata including the title of a music file, a singer's album, genre, language, and reproduction time, and a mood-based albuming tool 5220 for albuming music based on the mood of a music file.

FIG. 27 illustrates a structure of the video albuming tool 5300 for albuming video data according to an embodiment of the present invention. Referring to FIG. 27, the video albuming tool 5300 may be composed of a shot-based video albuming tool 5310 for albuming video data based on a basic unit shot of a video segment, a scene-based video albuming tool 5320 for albuming video data based on a scene having semantic information in addition to a shot, a genre-based video albuming tool 5330 for albuming video data based on a genre of a video file, and a person-identity-based video albuming tool 5340 for albuming based on a person included in a video file.

The media album description unit 160 generates album metadata for managing album information of multimedia contents by using the albumed result in operation 260. The database 170 stores the albumed multimedia contents and album metadata related to the albuming in operation 270.

A method of albuming multimedia contents by using the media albuming hints according to an embodiment of the present invention will now be explained in more detail.

First, it is assumed that there is a set, M, of N multimedia contents. The multimedia contents may be expressed as the following equation 1:
M={m₁,m₂,m₃, . . . ,m_{N}} (1)
where it is assumed that contents included in the content set M desired to be albumed have identical media format (image, audio, video).

An album hint corresponding to arbitrary j-th content mⱼ may be expressed as the following equation 2:
H={h₁,h₂,h₃, . . . ,h_{L}} (2)

where L is the number of albuming hint elements.

According to the expression method, an albuming hint set in relation to set M of N multimedia contents desired to be albumed is expressed as the following equation 3:
H={H₁,H₂,H₃, . . . ,H_{N}} (3)

K content-based feature values corresponding to arbitrary j-th content mⱼ are expressed as the following equation 4:
Fⱼ={f₁,f₂,f₃, . . . ,f_{K}} (4)

According to the expression method, a set of content-based feature values corresponding to set M of N multimedia contents desired to be albumed is expressed as the following equation 5:
F={F₁,F₂,F₃, . . . ,F_{N}} (5)

The present invention may include two methods of media albuming by using the albuming hints. The first method performs albuming only with albuming hints. The second method uses combinations by combining albuming hints with content-based feature values.

The first albuming method using media albuming hints will now be explained. It is assumed that N multimedia contents input first are indexed or clustered as an album label set G in order to perform albuming. Album label set G composed of T labels is expressed as the following equation 6:
G={g₁,g₂,g₃, . . . ,g_{T}} (6)

The method of indexing or clustering an arbitrary j-th content mⱼ only with albuming hints, as an i-th label gᵢ is expressed as the following equation 7:

$${L}_{j} = {g}_{i} ⨯ Φ ( {H}_{j} , {g}_{i} ) , where Φ ( {H}_{j} , {g}_{i} ) = \{ \begin{matrix}1 , & {\prod }_{l = 1}^{L} B ( {h}_{l} , {g}_{i} ) = 1 \\ 0 , & otherwise\end{matrix} \qquad ( 7 )$$

where function B(a,b) is a Boolean function in which when a=b, the function B is 1, or else 0, and the finally determined Lⱼ is the label of a j-th content mⱼ.

The second albuming method using media albuming hints will now be explained. First, by combining albuming hint Hⱼ of an arbitrary j-th content mⱼ with content-based feature value Fⱼ, new feature values are generated. The new combined feature value Fⱼ is expressed as the following equation 8:
Fⱼ′=⊖(Fⱼ,Hⱼ) (8)
where ⊖ is an arbitrary function for combining a content-based feature value and an albuming hint.

The new combined feature value is compared with a feature value learned with respect to label set G to obtain a similarity distance value, and a label having the highest similarity is determined as the label of the j-th content mⱼ. The method of determining the label of the j-th content mⱼ is expressed as the following equation 9:

$${L}_{j} = {arg min}_{g ∈ G} \{ D ( {F}_{j}^{′} , {F}_{G} ) \} \qquad ( 9 )$$

The present invention may also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the multimedia albuming system and method of the present invention, information related to obtaining multimedia contents and visual/audio information obtained from the contents of multimedia are utilized as hint information for albuming. By doing so, digital multimedia, such as digital photos, music, and video data (moving pictures), may be albumed automatically or semiautomatically. Also, media albuming hints included in the present method and apparatus may be used such that the performance of albuming functions, such as indexing or clustering with semantic information of multimedia contents, may be enhanced. Furthermore, by reducing the complexity of calculation required for albuming, the albuming may be performed much more efficiently.

Furthermore, by using information photo albuming hints, music albuming hints, and video albuming hints, parameters required to perform appropriately albuming of multimedia contents are defined, and effective description structures to describe the parameters are suggested. Accordingly, by using the described information, albuming of a large number of multimedia contents may be conveniently and easily performed.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A multimedia albuming method comprising:
extracting albuming hints information from multimedia contents;
describing the extracted albuming hints information in a predetermined description structure;
generating a media descriptor by using the described albuming hint information; and
albuming multimedia contents by using the media descriptor.

2. The method of claim 2, further comprising:
generating album metadata to manage album information of multimedia contents by using an albumed result; and
storing albumed multimedia contents and album metadata related to albuming in a database.

3. The method of claim 1, further comprising:
obtaining contents from a multimedia content acquisition apparatus and performing preprocessing; and
receiving inputs of the multimedia contents and the metadata corresponding to the multimedia contents obtained from the multimedia content acquisition apparatus.

4. The method of claim 1, wherein the albuming hint information comprises photo albuming hint information, music albuming hint information and video albuming hint information.

5. The method of claim 4, wherein the description structure of the photo albuming hint information comprises a description structure expressing information on a time when a photo is taken and camera information, a description structure expressing a perceptual characteristic of human beings with respect to contents of the photo, a description structure expressing information on a person included in the photo, a description structure expressing information on a view of the photo, and a description structure expressing information on a popularity of the photo.

6. The method of claim 5, wherein the description structure expressing information on a time when the photo is taken and camera information comprises at least one of information indicating whether photo data includes Exif information as metadata, photographer information, photographing time information, manufacturer information on a manufacturer of a camera with which the photo is taken, camera model information on a model of the camera with which a photo is taken, shutter speed information on a shutter speed when the photo is taken, color mode information on a color mode when the photo is taken, information indicating sensitivity of film when the photo is taken, information indicating whether a flash is used when the photo is taken, information indicating a degree of opening of an iris of a camera lens when the photo is taken, information indicating a distance of an optical zoom which is used when the photo is taken, information indicating a focal length when the photo is taken, information indicating a distance between a focused object and a camera when the photo is taken, GPS information in relation to a place where the photo is taken, information indicating a direction in which a first pixel of a photo image is located, as a direction of a camera when the photo is taken, information indicating sound recorded together when the photo is taken, and information indicating a thumbnail image stored for high-speed browsing in a camera after the photo is taken.

7. The method of claim 5, wherein the description structure expressing the perceptual characteristic of human beings with respect to the contents of a photo comprises at least one of an item (avgColorfulness) indicating a degree of colorful expression of the photo, an item (avgColorCoherence) indicating a degree of coherence of an entire color expressed in the photo, an item (avgLevelOfDetail) indicating a precision of the contents included in the photo, an item (avgHomogenity) indicating homogeneity of texture information of the contents of the photo, an item (avgPowerOfEdge) indicating a robustness of edge information of the contents included in the photo, an item (avgDepthOfField) indicating a depth of a focus of a camera with respect to the contents included in the photo, an item (avgBlurness) indicating a degree of blur of the contents of the photo by a shake occurring when a camera shutter is pressed, an item (avgGlareness) indicating a degree that the contents of the photo are hidden by light when a large quantity of flash light is used to take the photo or an external light source with a large quantity of strong light is used, and an item (avgBrightness) indicating an entire brightness of the photo.

8. The method of claim 7, wherein the item (avgColorfulness) indicating the degree of colorful expression of the photo is measured by normalizing a height of a histogram of each RGB color value from a color histogram and a distribution value of an entire color value, or by using a distribution value of colors measured by using CIE L*u*v* color space.

9. The method of claim 7, wherein the item (avgColorCoherence) indicating the degree of coherence of the color expressed in the photo is measured by using a Dominant Color descriptor selected from the group consisting of MPEG-7 visual descriptors, and is measured by normalizing a histogram height of each color value from a color histogram and a distribution value of an entire color value.

10. The method of claim 7, wherein the item (avgLevelOfDetail) indicating the precision of the contents included in the photo is measured by using entropy measured from pixel information of the photo, or by using an isopreference curve that is an element to determine an actual complexity of the photo, or by a relative measuring method in which compression ratios are compared with each other when compression is performed under substantially identical conditions.

11. The method of claim 7, wherein the item (avgHomogeneity) indicating homogeneity of texture information of the contents of the photo is measured using regularity, direction and scale of texture from feature values of a Texture Browsing descriptor selected from the group consisting of MPEG-7 visual descriptors.

12. The method of claim 7, wherein the item (avgPowerOfEdge) indicating the robustness of edge information of the contents included in the photo is measured by extracting edge information from the photo and normalizing a strength of an extracted edge.

13. The method of claim 7, wherein the item (avgDepthOfField) indicating the depth of the focus of the camera with respect to the contents included in the photo is measured generally by using a focal length of a camera lens, a diameter of the camera lens, and figures of an iris.

14. The method of claim 7, wherein the item (avgBlurness) indicating the degree of blur of the contents of the photo by a shake occurring when a camera shutter is pressed is measured using a power of an edge of the contents of the photo.

15. The method of claim 7, wherein the item (avgGlareness) indicating the degree that the contents of the photo are hidden by an external light source with a large quantity of strong light is measured by using a brightness of a photo pixel value.

16. The method of claim 7, wherein the item (avgBrightness) indicating the entire brightness of the photo is measured using a brightness of a photo pixel value.

17. The method of claim 5, wherein the description structure expressing information on the person included in the photo comprises an item indicating a number of persons included in the photo, an item indicating position information on a position of a face of each person and a position of clothes worn by the person, and an item indicating relationships among persons included in the photo.

18. The method of claim 17, wherein the item indicating position information on the position of the face of each person and the position of the clothes worn by the person comprises an identification of the person, and the position of the clothes worn by the person.

19. The method of claim 17, wherein the item indicating the relationships among persons included in the photo comprises an item indicating a first person of two persons whose relationship is to be indicated, an item indicating a second person of the two persons whose relationship is to be indicated, and an item indicating a relationship between the two persons.

20. The method of claim 5, wherein the description structure expressing information on the view of the photo comprises an item indicating whether a major part shown in the photo is a background or a foreground, an item indicating a position of a part corresponding to the background in the contents expressed in the photo, and an item indicating a position of a part corresponding to the foreground in the contents expressed in the photo.

21. The method of claim 4, wherein the description structure of the music albuming hint information comprises at least one of a description structure expressing information on a time when a music file is recorded, generated or edited, a description structure expressing a part that is a highlight of a music file, a description structure expressing a level of perceptual sound quality of a music file, a description structure expressing information on a mood of music, a description structure expressing information on a situation suitable to reproduce a music file, a description structure expressing media resource information on photos or moving pictures related to a music file, and a description structure expressing popularity or preference of a music file.

22. The method of claim 21, wherein in case of an MP3 file, the description structure expressing information on a time when music is recorded, generated or edited comprises at least one of a description structure indicating whether metadata in relation to a music file includes ID3 header information, a description structure indicating a title of a music file, a description structure indicating a name of a singer or player of music, a description structure indicating a genre of music, a description structure indicating a total reproduction time of a music file, a description structure indicating information on lyrics of music, and a description structure indicating a language of a music file.

23. The method of claim 4, wherein the description structure of the video albuming hint information comprises a description structure expressing information on major characters included in a video file, a description structure expressing a part that is a highlight of a video file, and a description structure expressing a popularity or preference of a video file.

24. The method of claim 1, wherein the described albuming hint information is used by a media description tool to generate a media descriptor that is metadata to describe media together with content-based feature value metadata.

25. The method of claim 1, wherein in the albuming of the multimedia contents, at least one of photo data, music data and video data is clustered or indexed using the media descriptor.

26. The method of claim 25, wherein the clustering or indexing of the photo data comprises at least one of:
albuming photos based on a situation in which a photo is taken;
albuming photos based on a semantic category included in the photo; and
albuming photos based on a person included in the photo.

27. The method of claim 25, wherein the clustering or indexing of the music data comprises at least one of:
albuming music based on ID3 metadata; and
albuming music based on a mood of a music file.

28. The method of claim 25, wherein the clustering or indexing of the video data comprises at least one of:
albuming video data based on a basic unit shot of a video segment;
albuming video data based on a scene having semantic information in addition to a shot;
albuming video data based on a genre of a video file; and
albuming based on a person included in the video file

29. The method of claim 1, wherein the albuming of the multimedia contents comprises at least one of:
albuming by using only media albuming hint information; and
albuming by combining media albuming hints with content-based feature values.

30. The method of claim 29, wherein in the albuming by using only media albuming hint information, a method of indexing or clustering an arbitrary j-th content mⱼ with an i-th label gᵢ by only using albuming hints is expressed as the following equation:
$${L}_{j} = {g}_{i} ⨯ Φ ( {H}_{j} , {g}_{i} ) , where Φ ( {H}_{j} , {g}_{i} ) = \{ \begin{matrix}1 , & {\prod }_{l = 1}^{L} B ( {h}_{l} , {g}_{i} ) = 1 \\ 0 , & otherwise\end{matrix}$$
where function B(a,b) is a Boolean function in which when a=b, the function B is 1, or else 0, and the finally determined Lⱼ is the label of a j-th content mⱼ.

31. The method of claim 29, wherein in the albuming by combining media albuming hints with content-based feature values, albuming hint Hⱼ of an arbitrary j-th content mⱼ is combined with content-based feature value Fⱼ, and the generated new feature value Fⱼ is expressed as the following equation:
Fⱼ′=⊖(Fⱼ,Hⱼ)
where ⊖ is an arbitrary function for combining a content-based feature value and an albuming hint.

32. The method of claim 31, wherein the new combined feature value is compared with a feature value learned with respect to label set G to obtain a similarity distance value, and a label having a highest similarity is determined to be a label of the j-th content mⱼ and, the label of the j-th content mⱼ is determined according to the following equation:
$${L}_{j} = {arg min}_{g ∈ G} \{ D ( {F}_{j}^{′} , {F}_{G} ) \}$$

33. A multimedia albuming system comprising:
a media albuming hint description structure providing unit generating a media albuming hint description structure;
an albuming hint extraction unit extracting albuming hint information from multimedia contents and describing albuming hints according to the media albuming hint description structure generated by the media albuming hint description structure providing unit;
a media description unit generating a media descriptor by using the described albuming hint information; and
a media albuming unit albuming multimedia contents by using the media descriptor.

34. The system of claim 33, further comprising:
a media album description unit generating album metadata to manage album information of multimedia contents by using albumed result; and
a database storing albumed multimedia contents and album metadata related to albuming in a database.

35. The system of claim 33, further comprising:
a media acquisition unit obtaining contents from a multimedia content acquisition apparatus and performing preprocessing; and
a media input unit receiving inputs of the multimedia contents and the metadata corresponding to the multimedia contents obtained from the multimedia content acquisition apparatus.

36. The system of claim 33, wherein the albuming hint information of the albuming hint extraction unit comprises photo albuming hint information, music albuming hint information and video albuming hint information.

37. The system of claim 36, wherein the description structure of the photo albuming hint information comprises at least one of a description structure expressing information on a time when a photo is taken and camera information, a description structure expressing a perceptual characteristic of human beings with respect to a contents of the photo, a description structure expressing information on a person included in the photo, a description structure expressing information on a view of the photo, and a description structure expressing information on a popularity of the photo.

38. The system of claim 36, wherein the description structure of the music albuming hint information comprises at least one of a description structure expressing information on a time when a music file is recorded, generated or edited, a description structure expressing a part that is a highlight of a music file, a description structure expressing a level of perceptual sound quality of a music file, a description structure expressing information on a mood of music, a description structure expressing information on a situation suitable to reproduce a music file, a description structure expressing media resource information on photos or moving pictures related to a music file, and a description structure expressing popularity or preference of a music file.

39. The system of claim 36, wherein the description structure of the video albuming hint information comprises a description structure expressing information on major characters included in a video file, a description structure expressing a part that is a highlight of a video file, and a description structure expressing a popularity or preference of a video file.

40. The system of claim 33, wherein the described albuming hint information is used by a media description tool to generate a media descriptor that is metadata to describe media together with content-based feature value metadata.

41. The system of claim 33, wherein the media albuming unit comprises at least one of:
a photo data albuming unit clustering or indexing photo data by using the media descriptor;
a music data albuming unit clustering or indexing music data by using the media descriptor; and
a video data albuming unit clustering or indexing video data by using the media descriptor.

42. The system of claim 41, wherein the photo data albuming unit comprises at least one of:
a situation-based photo albuming unit albuming photos based on a situation in which a photo is taken;
a category-based photo albuming unit albuming photos based on a semantic category included in the photo; and
a person-based photo albuming unit albuming photos based on a person included in the photo.

43. The system of claim 41, wherein the music data albuming unit comprises at least one of:
an ID3-based music albuming unit albuming music based on ID3 metadata including at least one of a title of a music file, a singer's album, a genre, a language, and reproduction time information; and
a mood-based music albuming unit albuming music based on a mood of a music file.

44. The system of claim 41, wherein the video data albuming unit comprises at least one of:
a shot-based video albuming unit albuming video data based on a basic unit shot of a video segment;
a scene-based video albuming unit albuming video data based on a scene having semantic information in addition to a shot;
a genre-based video albuming unit albuming video data based on a genre of a video file; and
a person-based video albuming unit albuming based on a person included in a video file.

45. The system of claim 33, wherein the media albuming unit performs albuming by using only media albuming hint information or by combining media albuming hints with content-based feature values.

46. A computer readable recording medium having embodied thereon a computer program for executing the method of claim 1.
